(19) United States
(12) Patent Application Publication
(10) Pub. No.: US 2002/0176072 A1
(43) Pub. Date: Nov. 28, 2002

(54) Device and method for controlling the quality of microdroplets deposited on a substrate

(76) Inventors: Stefan Beseki, Villingen-Schwenningen (DE); Holger Gruhler, Tuningen (DE); Roland Zengerle, Villingen-Schwenningen (DE)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/107,783

(22) PCT Filed: Oct. 5, 2000
(86) PCT No.: PCT/EP00/09773

(30) Foreign Application Priority Data
Oct. 5, 1999 (DE) 19947878.3

(51) Int. Cl. G01N 21/41

(52) U.S. Cl. 356/128

(57) ABSTRACT

A device for controlling the quality of microdroplets deposited on a substrate comprises a light source for illuminating the substrate which has the microdroplets deposited thereon. An image generator is provided for receiving the light which has been produced by the light source, fallen through the substrate or reflected by the substrate, so as to generate an image. Furthermore, an identifier and an analyzer are provided for analyzing the generated image with respect to patterns created in said image as a result of a refractive effect produced by microdroplets deposited on the substrate.

### BACKGROUND OF THE INVENTION

1. Field of the Invention

The present invention relates to a device and a method for controlling the quality of microdroplets deposited on a substrate, and in particular to a device and a method which are suitable for controlling the quality in the production of so-called microarrays. The designation microarray stands for a regular arrangement of microdroplets in liquid or dried form on a substrate. The arrangement in its entirety, i.e. the substrate having the microarray printed thereon, is often referred to as biochip. The microdroplets normally consist of a carrier solution in which substances are dissolved. The individual microdroplets of a microarray normally differ with respect to the substances dissolved in the droplets.

2. Description of Prior Art

Such a biochip can essentially be regarded as a highly parallel analysis instrument in the case of which a plurality of known substances is applied to a support substrate; the known substances can react in a specific way with another defined substance. When an unknown sample is brought into contact with the biochip, individual ones of the various spots of the microarray on the biochip will react with the sample liquid. By analyzing the reaction pattern on such a biochip, conclusions can be drawn with regard to the substances contained in the unknown sample. The variety of the various substances deposited on a biochip is therefore directly related to the plurality of analyses which can be carried out simultaneously, i.e. in parallel, by means of this biochip.

Taking into account that these biochips are used as analytic and diagnostic instruments, it becomes apparent that a continuous quality control is of the utmost importance in the production of these biochips.

For applying the various substances to the support substrate, three different techniques are essentially used, viz. online synthesis, contact printing or so-called “spotting” in the case of which the individual spots of the microarray are produced via a dispenser. When the microdroplets have been applied, they dry up, the substances dissolved in the liquid remaining on the substrate surface. When the substrate is introduced in a humid atmosphere, so that the humidity condenses at the locations where the substances are deposited, the original form of the microdroplets can be re-established.

For executing quality control during the production of these biochips, it is necessary to find out, after the application of the microdroplets, whether these microdroplets have been produced in an microarray and, if so, where they have been produced.

It is, for example, known to execute quality control via automatic image recognition in the case of which the image of the microdroplets on the support is recorded from above by means of a CCD camera and then evaluated. This picture can be used for determining the presence and the exact local position of each individual microdroplet in a microarray. The operational reliability of such image processing depends, however, strongly on the contrast with which the microdroplets stand out against the ambient background. In addition, contaminations, such a dust particles, can normally be discriminated from the microdroplets only with great difficulty or not at all, or they feign satellite droplets. It follows that the conventional set-up of such image processing often leads to mistakes in process control due to unsatisfactory quality control.

U.S. Pat. No. 5,508,200 discloses methods and devices for carrying out chemical analyses. For this purpose, chemical reactions between different reaction substances are first caused at different locations of a test area of a sample carrier. Following this, a complete digital image of the test area is recorded and processed so as to obtain quantitative test results with respect to the sample reactions at the different locations of the test area as a function of optical changes which occurred at the different locations in the test area.

### SUMMARY OF THE INVENTION

It is the object of the present invention to provide an economy-priced and functionally-reliable device and an economy-priced and functionally-reliable method for controlling the quality of microdroplets deposited on a substrate.

According to a first aspect of the invention, this object is achieved by a device for controlling the quality of microdroplets deposited on a substrate, comprising:

a light source for illuminating the substrate on which the microdroplets are deposited;

an image generator for receiving the light which has been produced by the light source and which has fallen through the substrate or reflected by the substrate so as to generate an image;

an identifier for identifying in said image patterns which are created by a refractive effect produced by the convex surface of transparent microdroplets deposited on the substrate; and

an analyser for analyzing the generated image based on the identified patterns with respect to at least the presence, the position or the size of microdroplets deposited on the substrate, microdroplets being discriminated from solid particles by said pattern.

According to a second aspect of the invention, the above object is achieved by A method for controlling the quality of microdroplets deposited on a substrate, comprising the steps of:

a) illuminating, by means of a light source, the substrate having the microdroplets deposited thereon;

b) receiving the light which has been produced by the light source and fallen through the substrate, or reflected by the substrate, so as to generate an image;

c) identifying in said image patterns which are created by a refractive effect produced by the convex surface of transparent microdroplets deposited on the substrate; and

d) analyzing the imagebased on the identified patterns with respect to at least the presence, the position or the size of microdroplets deposited on the substrate (2; 2′), microdroplets being discriminated from solid particles by said pattern.

The present invention is based on the finding that the refraction of light on curved surfaces of liquids can be utilized skilfully for executing quality control of microdroplets applied to a transparent or light-transmitting substrate or a reflecting substrate. The contrast of the image recorded is improved due to the utilization of the refraction of light, since the microdroplets can be discerned in the recorded image in the form of a pattern of very dark spots.

In this connection, it is utilized that, irrespectively of minor differences in the case of various combinations of materials, microdroplets always have a convex surface, this convex surface having with regard to the refraction of light properties which are similar to those of a convex lens. The strong optical refraction of light at a liquid droplet, which is produced by such a convex lens, can be utilized in the manner indicated hereinbefore for producing high-contrast pictures of the microdroplets.

In other words, the present invention utilizes the effect that the smaller the diameter of the microdroplets becomes, the stronger the curvature of the surface of the microdroplets will be. As has already been stated hereinbefore, these microdroplets with the curved surface can be regarded as microlenses, since the light is diffracted due to the different refractive indices at the boundary between the liquid and the ambient air. The stronger the curvature, i.e. the smaller the droplet, is, the shorter the focal length of these microlenses will be.

When the device and the method according to the present invention are used, the focal length of the microdroplets can be neglected in comparison with the distance of the image generation device. Light falling through the droplets from below will therefore be distributed in the whole upper half-space. The distance between the image generation device and the droplets is e.g. so large that the image generation device detects only a very small section, i.e. a section with a small solid angle, of this half-space.

When seen from the image generation device, this means that the microdroplets appear dark in comparison with their surroundings.

High-contrast pictures can be obtained when a transparent substrate is used as a support for e.g. a biochip having deposited thereon a microarray. This transparent substrate, which has the microarray deposited thereon, is introduced in the optical path between a homogeneous, diffuse light source and an image generation device so that the image generation device will see a white background at the locations at which no micro-liquid droplets are deposited, whereas the light will be diffracted at the other locations at which microdroplets are present. This will lead to a high-contrast image in which microdroplets can be discerned as a pattern of black spots.

Alternatively, the light source and the image generation device may be arranged on the same side of a reflecting substrate so that the image generation device receives light reflected by the substrate.

In addition, it is possible to discriminate microdroplets from solid particles, e.g. dust particles, very well by utilizing the circumstance that the microdroplets form an image of the whole surroundings in the image generation device so that they will also form an image of the light source, among other things, the light source being visible as a small spot of light at the centre of a microdroplet represented in the image as a dark spot. Dust particles having a defined, central hole, which would also produce such a small spot of light, are extremely unlikely so that, on the basis of the above-mentioned effect, liquid objects can unequivocally be discriminated from solids.

The device according to the present invention and the method according to the present invention can advantageously be used for online quality control by analyzing the image produced by the image generation device automatically by means of an image processing means which is capable of advantageously discerning the presence of microdroplets on the basis of the above-described special patterns produced by the microdroplets when the course of action according to the present invention is adopted. Hence, the present invention permits the provision of a system which is used for controlling the quality of microdroplets deposited on a substrate and which is moderate in price on the one hand and functionally reliable on the other. The substrate may be transparent, reflecting or partially transparent or partially reflecting. The present invention can advantageously be used in particular for controlling the quality in biochip production processes.

Further developments of the present invention are specified in the dependent claims.

### BRIEF DESCRIPTION OF THE DRAWINGS

In the following, preferred embodiments of the present invention will be explained in detail making reference to the drawings enclosed, in which:

FIG. 1 shows a schematic cross-sectional view for explaining the effect utilized by the present invention;

FIG. 2 shows a schematic representation of an embodiment of a device according to the present invention;

FIG. 3 shows a schematic representation of a generated image of a transparent substrate having microdroplets deposited thereon; and

FIG. 4 shows a schematic representation of a further embodiment of a device according to the present invention.

### DESCRIPTION OF PREFERRED EMBODIMENTS OF THE INVENTION

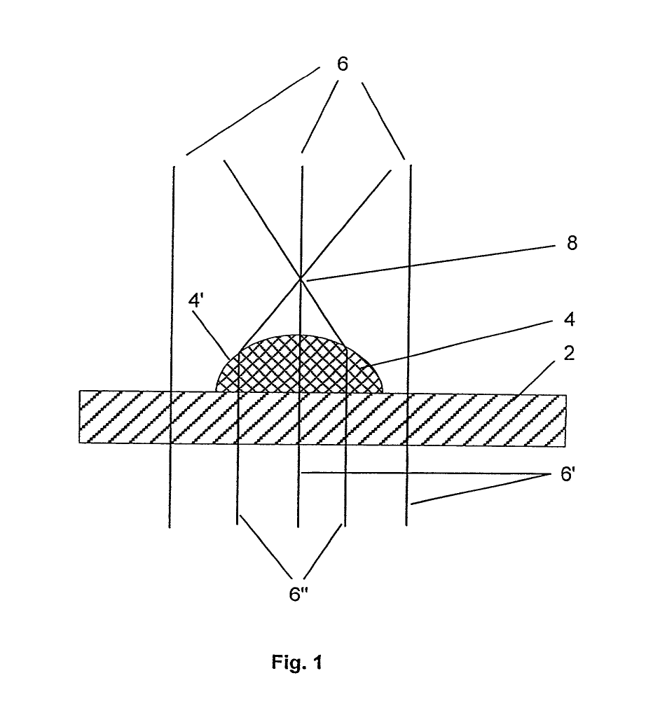

Making reference to FIG. 1, the effect utilized by the present invention will be explained first. For this purpose, a transparent substrate 2 is shown in FIG. 1, the surface of this substrate 2 having deposited thereon a microdroplet 4. The microdroplet 4 may e.g. be a microdroplet of a microarray of a biochip, the transparent substrate 2 being then the support substrate of the biochip. Reference numeral 6 designates in FIG. 1 light rays produced by a homogeneous, diffuse light source. Homogeneous light sources permitting the production of such parallel light rays 6 are known in the field of technology.

As can be seen in FIG. 1, the microdroplet 4, i.e. the liquid droplet, on the substrate 2 has a convex surface 4′. In this connection, reference should be made to the fact that the exact shape of a liquid droplet 4 on a substrate 2 depends on the surface tension of the liquid as well as on the surface properties of the substrate material. However, independently of minor differences in the case of various combinations of materials, a convex surface 4′ always exists.

As far as the refraction of light is concerned, this convex surface 4′ has properties similar to those of a convex lens, as indicated by the focus 8 shown in FIG. 1. The smaller the microdroplets on the substrate are, the stronger the curvature of the surface 4′ and, consequently, the refractive effect will be. Due to this refractive effect, refracted light rays 6″, which are produced by the curved surface 4′, are obtained in addition to undiffracted light rays 6′.

This strong optical refraction of light at a liquid droplet, which has been described hereinbefore making reference to FIG. 1, can now be used for producing high-contrast images of microdroplets.

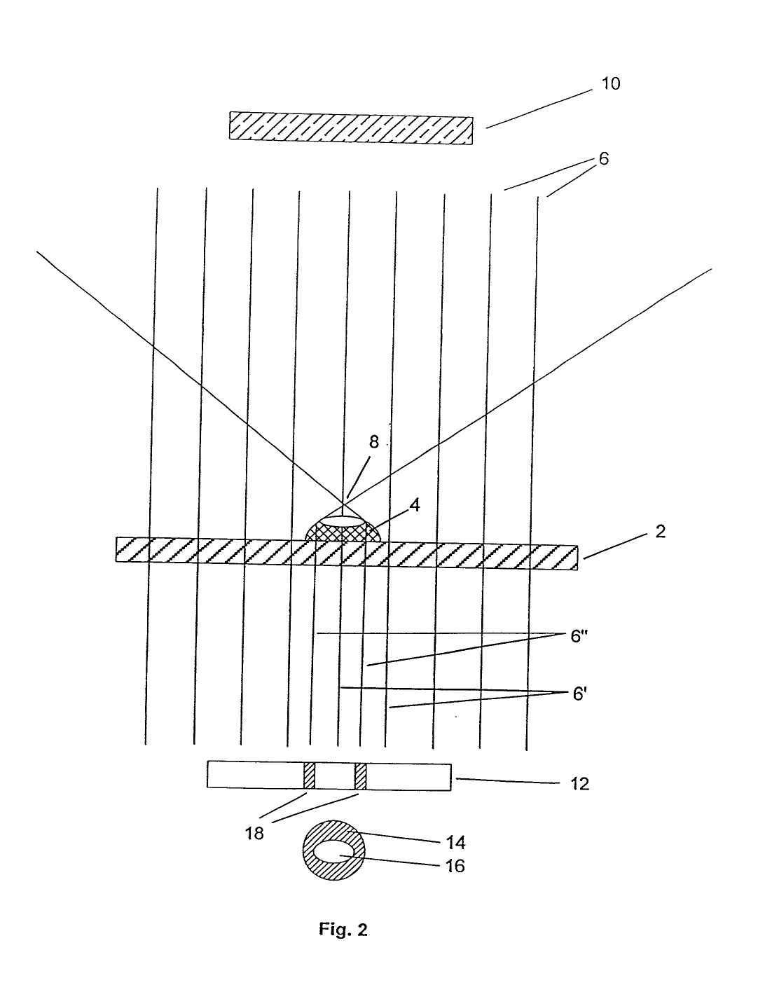

One embodiment of a set-up required for this purpose is shown, by way of example, in FIG. 2. This set-up includes a light source 10 producing parallel light rays 6, the transparent substrate 2, which has a microdroplet 4 deposited thereon, being introduced in the optical path of these parallel light rays 6. The light source 10 produces a homogeneous, diffuse illumination.

The homogeneous, diffuse light source can be an arbitrary known light source which is capable of producing parallel light rays 6. Furthermore, the light source 10 may comprise arbitrary optics for producing such light rays.

The focus 8 of the convex surface 4′ of the microdroplet 4, which produces a refractive effect, is also shown in FIG. 2. In addition, refracted light rays 6″ and undiffracted light rays 6′ are again shown in FIG. 2.

An optical detector 12 is arranged on the side of the transparent substrate 2 located opposite the light source 10; this optical detector 12 detects the light which has been emitted from the light source 10 and fallen through the transparent substrate 2, i.e. the refracted light rays 6″ and the undiffracted light rays 6″. The optical detector 12 may be a conventional camera, e.g. a CCD camera.

In the configuration shown, in which the light source 10, the substrate 2 and the camera 12 are arranged in one “line”, the optical detector 12 produces very bright or white image areas where no liquid droplets 4 are deposited on the substrate 2. There the camera 12 sees a white background. At the other locations at which microdroplets, e.g. the microdroplet 4, are present, the light is refracted, as has been described hereinbefore, the microdroplets producing an effect corresponding to that of microlenses which form an image of the whole surroundings in the camera. Since, in comparison with the light produced by the light source, the ambient brightness is much darker, the microdroplets 4 appear as very dark areas on the image produced by the camera 12, as can be seen from the schematic representation in FIG. 2, reference numeral 14.

The microdroplets form an image of the whole surroundings in the camera so that also an image of the light source will be formed, which appears as a small spot of light 16 at the centre of the dark area produced by the microdroplet. It follows that the microdroplet 4 causes the formation of an image which is schematically shown in FIG. 2 where it is designated by reference numerals 14 and 16. In addition, this image is schematically shown by dark areas 18 in the optical detector 12.

The set-up shown in FIG. 2 therefore provides high-contrast images in which very dark microdroplets appear in front of a very bright background.

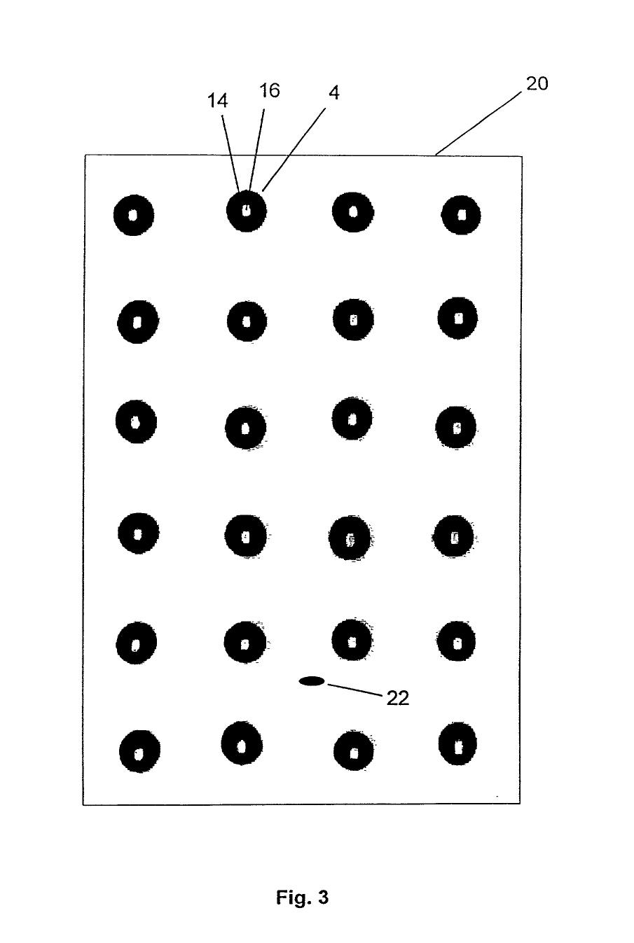

An image 20 of a microarray which has been produced by such a set-up is shown in FIG. 3, where the microarray comprises 4×6 microdroplets, i.e. 24 microdroplets, only one of these microdroplets being designated by reference numeral 4 in FIG. 3. As can be seen in FIG. 3, each of these microdroplets produces a dark spot 14 in this image; at the centre of this dark spot 14, a small spot of light 16 can be seen, which is produced by the image of the light source. By means of this light spot, dust particles can be discriminated very well from liquid droplets in an image which has been produced in this way and which is shown in FIG. 3. In a set-up of the type shown in FIG. 2, dust particles produce a dark spot having no small spot of light at the Centre thereof.

Such a spot is shown e.g. at 22 in FIG. 3. With the aid of suitable image processing means, such a spot 22 can easily be discriminated from the spots having a bright spot at the centre thereof so that it will be possible to discriminate microdroplets automatically from dust particles.

It should here be pointed out that dust particles having a defined central hole which would produce a light spot similar to that produced by microdroplets are extremely unlikely so that, on the basis of the above-described effect, liquid objects producing a refractive effect can unequivocally be discriminated from solids producing no refractive effect.

Reference should be made to the fact that, due to the direct counterlight in the set-up shown in FIG. 2, comparatively small dust particles will be swamped out completely so that they will not be detected when the image is being processed and need not be filtered consequently. A spot 22 produced by a larger dust particle in the manner described hereinbefore can, however, be filtered out of the image by suitable filtering mechanisms.

Once it has been recorded, the image shown in FIG. 3 can be analyzed with regard to the presence, the position and/or the size of microdroplets.

In contrast to conventional systems, the set-up described is extremely insensitive to stray light or the general brightness in the room in question, since the brightness of the stray light or the general brightness of the room in question are negligible in comparison with the brightness of the background. This is due to the fact that the camera looks so to speak directly into the light source, as can clearly be seen from FIG. 2.

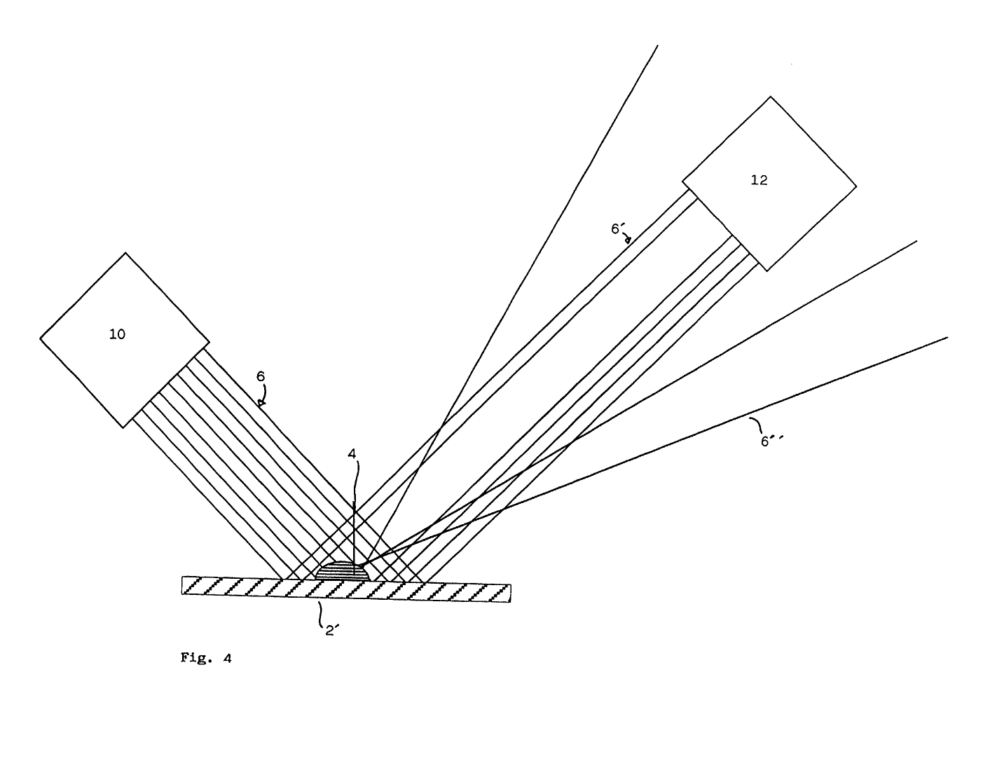

An alternative embodiment of a device according to the present invention is shown in FIG. 4. In the case of this embodiment, the light source 10 and the image generation device 12 are arranged on the same side of a reflecting or at least partially reflecting substrate 2′. The light 6 produced by the light source 10 is reflected into the image generation device 12 without being disturbed by the substrate 2′, unless it passes through the microdroplets, as schematically indicated by the rays 6′. If the rays 6 impinge, however, on the droplets 4, these droplets will again produce an effect corresponding to that of lenses which distribute the light rays into a large solid angle, as schematically indicated by the rays 6″. Most of these light rays will miss the image generation device 12. It follows that, to the image generation device 12, the droplets 4 again seem to be very dark in comparison with the areas of the substrate where no droplets are present.

The above-described set-ups according to the present invention can be optimized still further by the use of additional lenses, these lenses being used such that the best possible image of the extended light source is formed in the camera. It is also possible to install reflecting mirrors, either between the transparent substrate 2 and the light source 10 or between the transparent substrate 2 and the optical detector 12 so that the spatial arrangement of the individual elements will be flexible.

It follows that the present invention permits an economy-priced and functionally-reliable quality control of microdroplets deposited on a substrate, the invention being particularly suitable for quality control in the production of microarrays. The present invention is especially suitable for online quality control, and mistakes in process control can be minimized by the reliability of the invention.

What is claimed is:

1. A device for controlling the quality of microdroplets deposited on a substrate, comprising:
a light source for illuminating the substrate on which the microdroplets are deposited;
an image generator for receiving the light which has been produced by the light source and which has fallen through the substrate or reflected by the substrate so as to generate an image;
an identifier for identifying in said image patterns which are created by a refractive effect produced by the convex surface of transparent microdroplets deposited on the substrate; and
an analyser for analyzing the generated image based on the identified patterns with respect to at least the presence, the position or the size of microdroplets deposited on the substrate, microdroplets being discriminated from solid particles by said pattern.

2. A device according to claim 1, wherein the substrate is a transparent substrate and the image generator is arranged such that it is adapted to receive light that has fallen through said substrate.

3. A device according to claim 2, wherein the light source and the image generator are arranged in opposed relationship with each other, the transparent substrate being adapted to be positioned therebetween.

4. A device according to claim 1, wherein the substrate is a reflecting substrate and the image generator is arranged such that it is adapted to receive light reflected by said substrate.

5. A device according to claim 1, wherein the light source produces a homogeneous, diffuse illumination.

6. A device according to claim 1, which additionally comprises a lens arrangement for forming an optimum image of the diffuse light source in the image generator.

7. A device according to claim 1, which additionally comprises reflecting mirrors.

8. A method for controlling the quality of microdroplets deposited on a substrate, comprising the steps of:
a) illuminating, by means of a light source, the substrate having the microdroplets deposited thereon;
b) receiving the light which has been produced by the light source and fallen through the substrate, or reflected by the substrate, so as to generate an image;
c) identifying in said image patterns which are created by a refractive effect produced by the convex surface of transparent microdroplets deposited on the substrate; and
d) analyzing the image based on the identified patterns with respect to at least the presence, the position or the size of microdroplets deposited on the substrate (2; 2′), microdroplets being discriminated from solid particles by said pattern.

9. A method according to claim 8, wherein the substrate is a transparent substrate and light which has fallen through said substrate is received in step b).

10. A method according to claim 8, wherein the substrate is a transparent substrate and light which has been reflected by said substrate is received in step b).

11. A method according to claim 8, wherein the microdroplets are formed by substances dissolved in a carrier solution.
